(19) United States
(12) Patent Application Publication
(10) Pub. No.: US 2010/0245463 A1
(43) Pub. Date: Sep. 30, 2010

(54) INKJET HEAD CLEANING APPARATUS, IMAGE RECORDING APPARATUS AND INKJET HEAD CLEANING METHOD

(76) Inventor: Noriaki MAIDA, Kanagawa-ken (JP)

Correspondence Address: BIRCH STEWART KOLASCH & BIRCH, PO BOX 747, FALLS CHURCH, VA, 22040-0747, US

(21) Appl. No.: 12/730,929

(22) Filed: Mar. 24, 2010

(30) Foreign Application Priority Data
Mar. 25, 2009 (JP) 2009-074824

(51) Int. Cl. B41J 2/165

(52) U.S. Cl. 347/28

(57) ABSTRACT

The inkjet head cleaning apparatus includes: cleaning liquid nozzles through which cleaning liquid is applied to a liquid ejection surface of an inkjet head in which the liquid ejection surface is oblique to horizontal, the cleaning liquid nozzles being arranged in a cleaning liquid emission surface arranged with an inclination so as to face the liquid ejection surface, the cleaning liquid nozzles being arranged in a line substantially parallel with a direction of the inclination of the cleaning liquid emission surface; and a pressure application device which applies pressure to the cleaning liquid to be emitted through the cleaning liquid nozzles, wherein the pressure applied by the pressure application device to the cleaning liquid supplied to the cleaning liquid nozzles on an upper side is greater than the pressure applied by the pressure application device to the cleaning liquid supplied to the cleaning liquid nozzles on a lower side.

### BACKGROUND OF THE INVENTION

1. Field of the Invention

The present invention relates to an inkjet head cleaning apparatus, an image recording apparatus and an inkjet head cleaning method, and more particularly to technology for cleaning a liquid ejection surface of an inkjet head.

2. Description of the Related Art

As a general image recording apparatus, it is suitable to use an inkjet recording apparatus, which forms a desired image on a recording medium by ejecting and depositing colored inks from a plurality of nozzles provided in an inkjet head. If the inkjet head is operated for a long period of time, adhering matter such as solidified ink or paper dust from the recording medium, and the like, adhere to the nozzle surface. In particular, if adhering matter becomes attached to the vicinity of the nozzles and the nozzle apertures, this gives rise to deflection of the ejection direction of the ink ejected from the nozzles, or reduction in the ejection volume, and so on, and therefore an inkjet recording apparatus is composed in such a manner that cleaning of the nozzle surface is carried out appropriately.

Japanese Patent Application Publication No. 2000-094703 discloses a cleaning apparatus which applies a cleaning liquid in a non-contact fashion to an inkjet head, by rotating an application roller having a cylindrical shape which is immersed in the cleaning liquid.

An inkjet recording apparatus which employs a drum conveyance method whereby a recording medium is held on the outer circumferential surface of a round cylindrical conveyance drum and conveyed on the outer circumferential surface of the conveyance drum, as a device for conveying the recording medium, is disposed obliquely to the horizontal plane in such a manner that the recording head faces the outer circumferential surface of the conveyance drum.

A cleaning apparatus 260 shown in FIG. 15 has a cleaning liquid application unit 262 which holds a cleaning liquid 261 on a surface 262A facing the nozzle surface 272A of the inkjet head (head) 272, and employs a method which brings the cleaning liquid 261 into contact with the nozzle surface 272A to apply cleaning liquid to the nozzle surface 272A. FIG. 15 is a diagram of a full line type head 272 viewed from the breadthways direction thereof, and the direction passing through the plane of the drawing is the lengthwise direction of the head 272.

When the nozzle surface 272A of the head 272 that is arranged obliquely to the horizontal plane is cleaned by using the above-described cleaning apparatus 260, then the cleaning liquid 261 collects on the inclined lower side 262C rather than being held on the inclined upper side 262B, and it is difficult to apply the cleaning liquid uniformly to the nozzle surface 272A. For example, if a composition is adopted in which nozzles for emitting cleaning liquid are arranged on a surface facing the nozzle surface 272A and the cleaning liquid is emitted in the form of a shower by using a high pressure, then it is possible to form a coating layer of the cleaning liquid over the whole of the surface on which the cleaning liquid is emitted, but there is a large variation in pressure distribution between the inclined upper side and lower side, and there is a risk of breakdown of the meniscus formed in the nozzles positioned in the nozzle surface 272A of the head 272, corresponding to the region where the pressure is high. Consequently, a method which adjusts the pressure for emitting the cleaning liquid uniformly in the whole of the cleaning apparatus 260 is not desirable.

The cleaning apparatus described in Japanese Patent Application Publication No. 2000-094703 requires the speed of rotation of the application roller to be high in order to provide the application roller with a coating layer of a certain thickness of the cleaning liquid. On the other hand, since the flow speed of the applied cleaning liquid becomes high if the speed of rotation of the application roller is high, and the flow speed of the cleaning liquid is greatest in the vicinity of the inkjet head, then there is a risk that the meniscus formed inside the nozzles arranged in the surface (nozzle surface) of the inkjet head will break down. If the meniscus breaks down, then this causes ejection failures and leads to decline in the printing performance. Furthermore, if the speed of rotation of the application roller is too high, then violent eddies are created in the cleaning liquid and stable application of the cleaning liquid becomes impossible. Consequently, there are limits on the thickness of the coating layer of the cleaning liquid for achieving stable application of the cleaning liquid (approximately 0.5 mm in the case of the cleaning apparatus described in Japanese Patent Application Publication No. 2000-094703). Therefore, it is necessary to very precisely adjust the interval between the cleaning apparatus and the nozzle surface of the head, and sufficient attention must be given to the accuracy of assembly.

### SUMMARY OF THE INVENTION

The present invention has been contrived in view of these circumstances, an object thereof being to provide an inkjet head cleaning apparatus, an image recording apparatus and an inkjet head cleaning method, whereby cleaning liquid is applied uniformly to a nozzle surface arranged obliquely to the horizontal plane.

In order to attain the aforementioned object, the present invention is directed to an inkjet head cleaning apparatus, comprising: a plurality of cleaning liquid nozzles through which cleaning liquid is applied to a liquid ejection surface of an inkjet head in which the liquid ejection surface is oblique to a horizontal plane, the cleaning liquid nozzles being arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface; a plurality of flow channels which are connected respectively to the cleaning liquid nozzles; a cleaning liquid inlet port through which the cleaning liquid is supplied to the cleaning liquid nozzles through the flow channels; and a pressure application device which applies pressure to the cleaning liquid to be emitted through the cleaning liquid nozzles, wherein the pressure applied by the pressure application device to the cleaning liquid supplied to the cleaning liquid nozzles on an upper side of the inclined cleaning liquid emission surface is greater than the pressure applied by the pressure application device to the cleaning liquid supplied to the cleaning liquid nozzles on a lower side of the inclined cleaning liquid emission surface.

According to the present invention, in the cleaning liquid nozzles arranged in substantially the same direction as the inclination of the inkjet head which is arranged with the liquid ejection surface oblique to the horizontal plane, the pressure differential arising between the cleaning liquid nozzles on the upper side of the inclination and the cleaning liquid nozzles on the lower side of the inclination can be made uniform, and a prescribed amount of the cleaning liquid can be applied stably to the nozzle surface oblique to the horizontal plane.

### BRIEF DESCRIPTION OF THE DRAWINGS

FIG. 1 is a general schematic drawing of an inkjet image recording apparatus according to an embodiment of the present invention;

FIG. 2 is a plan view diagram showing an embodiment of the composition of an inkjet head in FIG. 1;

FIG. 3 is a partial enlarged view of FIG. 2;

FIGS. 4A to 4C are plan view perspective diagrams of a head module in FIG. 2;

FIG. 5 is a cross-sectional diagram showing the inner composition of an ink chamber unit;

FIG. 6 is a general schematic drawing of a head maintenance unit according to an embodiment of the present invention;

FIG. 7 is a side view of a cleaning liquid application unit in FIG. 6;

FIG. 8 is a plan diagram of a cleaning liquid emission surface showing an embodiment of the arrangement of cleaning liquid nozzles;

FIG. 9 is a diagram showing the relative arrangement of the cleaning processing unit and the head in FIG. 7;

FIG. 10 is a cross-sectional diagram of a cleaning liquid application unit in FIG. 9;

FIG. 11 is a principal block diagram showing the system configuration of the inkjet image recording apparatus in FIG. 1;

FIG. 12 is a general schematic drawing of a cleaning processing unit according to a first modified embodiment;

FIG. 13 is a cross-sectional diagram of a cleaning liquid application unit according to a second modified embodiment;

FIG. 14 is a cross-sectional diagram of a cleaning liquid application unit according to a third modified embodiment; and

FIG. 15 is a diagram for describing the related art.

### DETAILED DESCRIPTION OF THE PREFERRED EMBODIMENTS

### Entire Configuration of Inkjet Recording Apparatus

First, an inkjet recording apparatus will be described as an embodiment of an image recording apparatus according to the present invention.

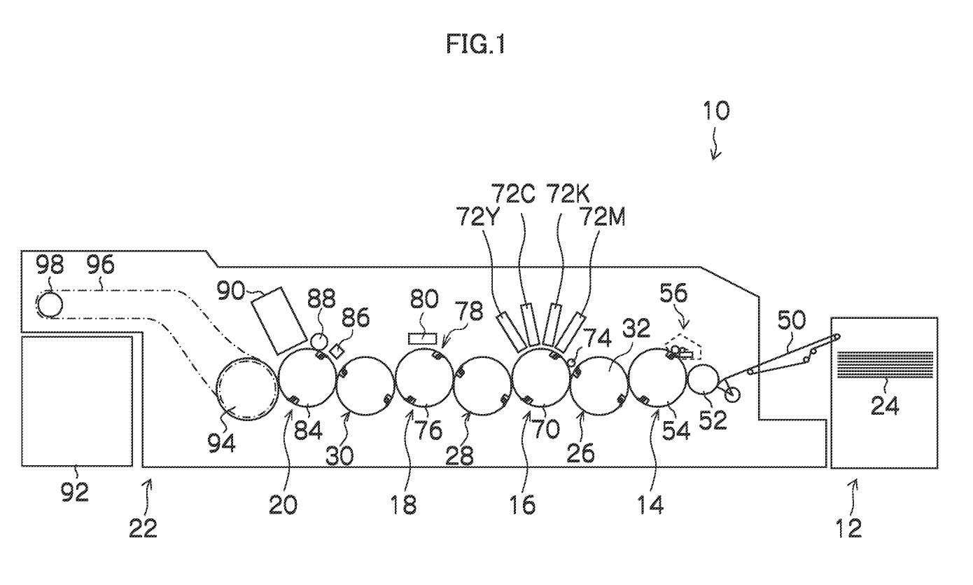

FIG. 1 is a structural diagram illustrating the entire configuration of an inkjet recording apparatus 10 according to an embodiment of the present invention. The inkjet recording apparatus 10 shown in the drawing is an recording apparatus in a two-liquid aggregating system of forming an image on a recording surface of a recording medium 24 by using ink (an aqueous ink) and a treatment liquid (aggregation treatment liquid). The inkjet recording apparatus 10 includes a paper feed unit 12, a treatment liquid application unit 14, an image formation unit 16, a drying unit 18, a fixing unit 20, and a discharge unit 22 as the main components. A recording medium 24 (paper sheets) is stacked in the paper feed unit 12, and the recording medium 24 is fed from the paper feed unit 12 to the treatment liquid application unit 14. A treatment liquid is applied to the recording surface in the treatment liquid application unit 14, and then a color ink is applied to the recording surface in the image formation unit 16. The image is fixed with the fixing unit 20 on the recording medium 24 onto which the ink has been applied, and then the recording medium is discharged with the discharge unit 22.

In the inkjet recording apparatus 10, intermediate conveyance units 26, 28 and 30 are provided between the units, and the recording medium 24 is transferred by these intermediate conveyance units 26, 28 and 30. Thus, a first intermediate conveyance unit 26 is provided between the treatment liquid application unit 14 and image formation unit 16, and the recording medium 24 is transferred from the treatment liquid application unit 14 to the image formation unit 16 by the first intermediate conveyance unit 26. Likewise, the second intermediate conveyance unit 28 is provided between the image formation unit 16 and the drying unit 18, and the recording medium 24 is transferred from the image formation unit 16 to the drying unit 18 by the second intermediate conveyance unit 28. Further, a third intermediate conveyance unit 30 is provided between the drying unit 18 and the fixing unit 20, and the recording medium 24 is transferred from the drying unit 18 to the fixing unit 20 by the third intermediate conveyance unit 30.

Each unit (paper feed unit 12, treatment liquid application unit 14, image formation unit 16, drying unit 18, fixing unit 20, discharge unit 22, and first to third intermediate conveyance units 26, 28 and 30) of the inkjet recording apparatus 10 will be described below in greater details.

### <Paper Feed Unit>

The paper feed unit 12 feeds the recording medium 24 to the image formation unit 16. A paper feed tray 50 is provided in the paper feed unit 12, and the recording medium 24 is fed, sheet by sheet, from the paper feed tray 50 to the treatment liquid application unit 14.

### <Treatment Liquid Application Unit>

The treatment liquid application unit 14 is a mechanism that applies a treatment liquid to the recording surface of the recording medium 24. The treatment liquid includes a coloring material aggregating agent that causes the aggregation of a coloring material (pigment) included in the ink applied in the image formation unit 16, and the separation of the coloring material and a solvent in the ink is enhanced when the treatment liquid is brought into contact with the ink.

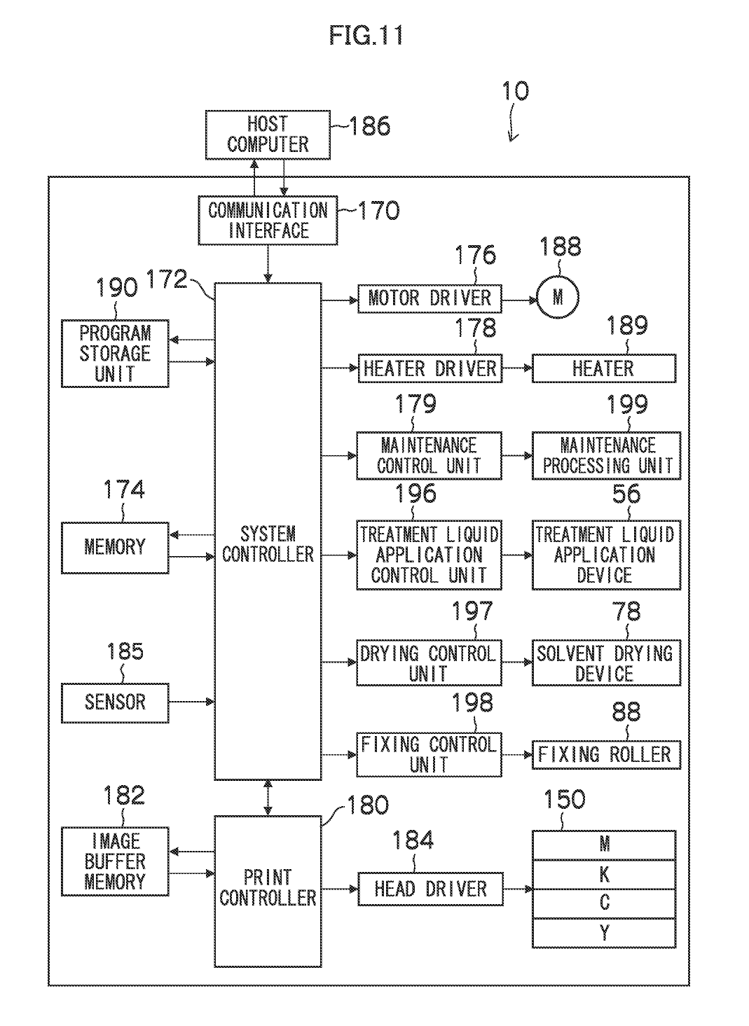

As shown in FIG. 1, the treatment liquid application unit 14 includes a paper transfer drum 52, a treatment liquid drum 54, and a treatment liquid application device 56. The paper transfer drum 52 is disposed between the paper feed tray 50 of the paper feed unit 12 and the treatment liquid drum 54. The rotation of the paper transfer drum 52 is driven and controlled by a below-described motor driver 176 (see FIG. 11). The recording medium 24 fed from the paper feed unit 12 is received by the paper transfer drum 52 and transferred to the treatment liquid drum 54. The below-described intermediate conveyance unit may be also provided instead of the paper transfer drum 52.

The treatment liquid drum 54 is a drum that holds and rotationally conveys the recording medium 24. The rotation of the treatment liquid drum 54 is driven and controlled by the below-described motor driver 176 (see FIG. 11). Further, the treatment liquid drum 54 is provided on the outer circumferential surface thereof with a hook-shaped holding device, by which the leading end of the recording medium 24 can be held. In a state in which the leading end of the recording medium 24 is held by the holding device, the treatment liquid drum 54 is rotated to rotationally convey the recording medium 24. In this case, the recording medium 24 is conveyed in a state where the recording surface thereof faces outward. The treatment liquid drum 54 may be provided with suction apertures on the outer circumferential surface thereof and connected to a suction device that performs suction from the suction apertures. As a result, the recording medium 24 can be held in a state of tight adherence to the outer circumferential surface of the treatment liquid drum 54.

The treatment liquid application device 56 is provided on the outside of the treatment liquid drum 54 opposite the outer circumferential surface thereof. The treatment liquid application device 56 applies the treatment liquid onto the recording surface of the recording medium 24. The treatment liquid application device 56 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 24 that is held by the treatment liquid drum 54, so as to transfer the treatment liquid metered by the anilox roller 64 to the recording medium 24.

With the treatment liquid application device 56 of the above-described configuration, the treatment liquid is applied onto the recording medium 24, while being metered. In this case, it is preferred that the film thickness of the treatment liquid be sufficiently smaller than the diameter of ink droplets that are ejected from inkjet heads 72M, 72K, 72C and 72Y of the image formation unit 16.

In the present embodiment, the application system using the roller is used to deposit the treatment liquid onto the recording surface of the recording medium 24; however, the present invention is not limited to this, and it is possible to employ a spraying method, an inkjet method, or other methods of various types.

### <Image Formation Unit>

The image formation unit 16 is a mechanism which prints an image corresponding to an input image by ejecting and depositing droplets of ink by an inkjet method, and the image formation unit 16 includes an image formation drum 70, a paper pressing roller 74 and the inkjet heads 72M, 72K, 72C and 72Y. The inkjet heads 72M, 72K, 72C and 72Y correspond to inks of four colors: magenta (M), black (K), cyan (C) and yellow (Y), and are disposed in the order of description from the upstream side in the rotation direction of the image formation drum 70.

The image formation drum 70 is a drum that holds the recording medium 24 on the outer circumferential surface thereof and rotationally conveys the recording medium 24. The rotation of the image formation drum 70 is driven and controlled by the below-described motor driver 176 (see FIG. 11). Further, the image formation drum 70 is provided on the outer circumferential surface thereof with a hook-shaped holding device, by which the leading end of the recording medium 24 can be held. In a state in which the leading end of the recording medium 24 is held by the holding device, the image formation drum 70 is rotated to rotationally convey the recording medium 24. In this case, the recording medium 24 is conveyed in a state where the recording surface thereof faces outward, and inks are deposited on the recording surface by the inkjet heads 72M, 72K, 72C and 72Y.

The paper pressing roller 74 is a guide member for causing the recording medium 24 to tightly adhere to the outer circumferential surface of the image formation drum 70, and is arranged so as to face the outer circumferential surface of the image formation drum 70. More specifically, the paper pressing roller 74 is disposed to the downstream side of the position where transfer of the recording medium 24 is received, and to the upstream side from the inkjet heads 72M, 72K, 72C and 72Y, in terms of the direction of conveyance of the recording medium 24 (the direction of rotation of the image formation drum 70).

When the recording medium 24 that has been transferred onto the image formation drum 70 from the intermediate conveyance unit 26 is rotationally conveyed in a state where the leading end portion of the recording medium 24 is held by the holding device, the recording medium 24 is pressed by the paper pressing roller 74 to tightly adhere to the outer circumferential surface of the image formation drum 70. When the recording medium 24 has been made to tightly adhere to the outer circumferential surface of the image formation drum 70 in this way, the recording medium 24 is conveyed to a print region directly below the inkjet heads 72M, 72K, 72C and 72Y in a state where the recording medium 24 does not float up at all from the outer circumferential surface of the image formation drum 70.

The inkjet heads 72M, 72K, 72C and 72Y are inkjet heads (inkjet heads) of the inkjet system of the full line type that have a length corresponding to the maximum width of the image formation region in the recording medium 24. A nozzle row is formed on the ink ejection surface of the inkjet head. The nozzle row has a plurality of nozzles arranged therein for discharging ink over the entire width of the image recording region. Each of the inkjet heads 72M, 72K, 72C and 72Y is fixedly disposed so as to extend in the direction perpendicular to the conveyance direction (rotation direction of the image formation drum 70) of the recording medium 24.

Furthermore, each of the inkjet heads 72M, 72K, 72C and 72Y is disposed obliquely to the horizontal plane, in such a manner that each of the nozzle surfaces of the inkjet heads 72M, 72K, 72C and 72Y is substantially parallel to the recording surface of the recording medium 24 held on the outer circumferential surface of the image formation drum 70.

Droplets of corresponding colored inks are ejected from the inkjet heads 72M, 72K, 72C and 72Y having the above-described configuration toward the recording surface of the recording medium 24 held on the outer circumferential surface of the image formation drum 70. As a result, the ink comes into contact with the treatment liquid that has been heretofore applied on the recording surface by the treatment liquid application unit 14, the coloring material (pigment) dispersed in the ink is aggregated, and a coloring material aggregate is formed. Therefore, the coloring material flow on the recording medium 24 is prevented and an image is formed on the recording surface of the recording medium 24. In this case, because the image formation drum 70 of the image formation unit 16 is structurally separated from the treatment liquid drum 54 of the treatment liquid application unit 14, the treatment liquid does not adhere to the inkjet heads 72M, 72K, 72C and 72Y, and the number of factors preventing the ejection of ink can be reduced.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

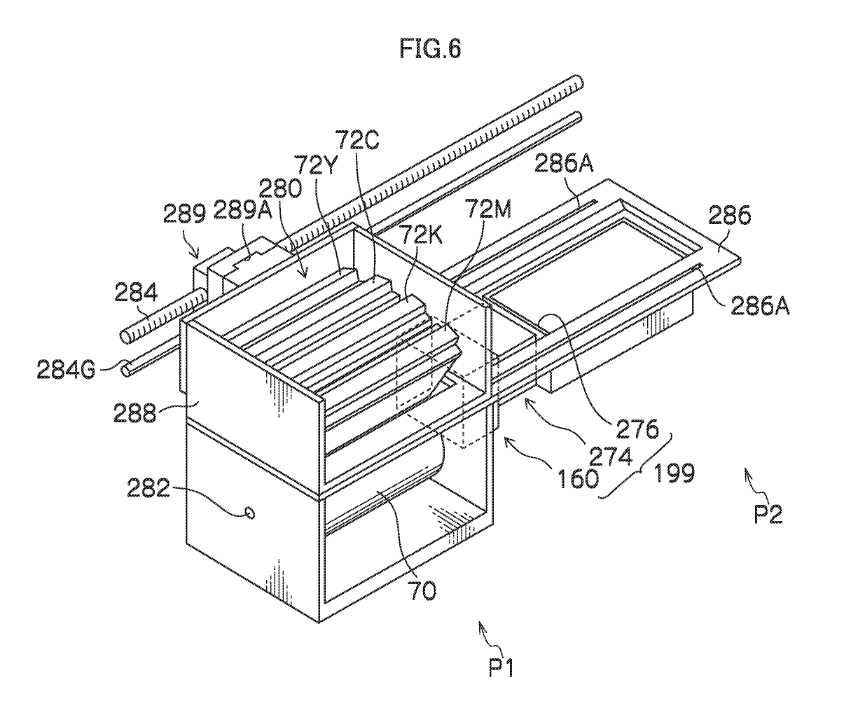

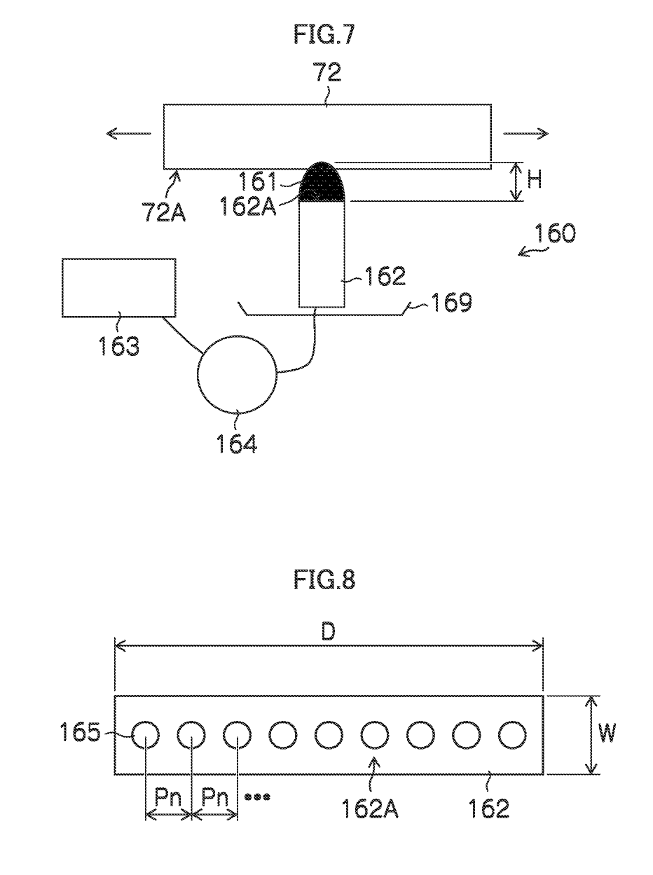

Although not shown in FIG. 1, the inkjet recording apparatus 10 is provided with a maintenance processing unit 199 (see FIG. 6) including a cleaning processing unit 160 (see FIG. 7) which cleans a nozzle surface 72A (see FIG. 7) of each of the inkjet heads 72M, 72K, 72C and 72Y, and the maintenance processing unit 199 is arranged nearby the image formation drum 70. The maintenance processing unit 199 and the cleaning processing unit 160 will be described below in greater details.

### <Drying Unit>

The drying unit 18 dries water included in the solvent separated by the coloring material aggregation action. As shown in FIG. 1, the drying unit includes a drying drum 76 and a solvent dryer 78.

The drying drum 76 is a drum that holds the recording medium 24 on the outer circumferential surface thereof and rotationally conveys the recording medium 24. The rotation of the drying drum 76 is driven and controlled by the below-described motor driver 176 (see FIG. 11). Further, the drying drum 76 is provided on the outer circumferential surface thereof with a hook-shaped holding device, by which the leading end of the recording medium 24 can be held. In a state in which the leading end of the recording medium 24 is held by the holding device, the drying drum 76 is rotated to rotationally convey the recording medium. In this case, the recording medium 24 is conveyed in a state where the recording surface thereof faces outward. The drying treatment is carried out by the solvent dryer 78 with respect to the recording surface of the recording medium 24. The drying drum 76 may be provided with suction apertures on the outer circumferential surface thereof and connected to a suction device that performs suction from the suction apertures. As a result, the recording medium 24 can be held in a state of tight adherence to the outer circumferential surface of the drying drum 76.

The solvent dryer 78 is disposed in a position facing the outer circumferential surface of the drying drum 76, and includes a halogen heater 80. The halogen heater 80 is controlled to blow warm air at a prescribed temperature at a constant blowing rate toward the recording medium 24.

With the solvent dryer 78 of the above-described configuration, water included in the ink solvent on the recording surface of the recording medium 24 held by the drying drum 76 is evaporated, and drying treatment is performed. In this case, because the drying drum 76 of the drying unit 18 is structurally separated from the image formation drum 70 of the image formation unit 16, the number of ink non-ejection events caused by drying of the head meniscus portion by thermal drying can be reduced in the inkjet heads 72M, 72K, 72C and 72Y. Further, there is a degree of freedom in setting the temperature of the drying unit 18, and the optimum drying temperature can be set.

By holding the recording medium 24 in such a manner that the recording surface thereof is facing outward on the outer circumferential surface of the drying drum 76 having this composition (in other words, in a state where the recording surface of the recording medium 24 is curved in a convex shape), and drying while conveying the recording medium in rotation, it is possible to prevent the occurrence of wrinkles or floating up of the recording medium 24, and therefore drying non-uniformities caused by these phenomena can be prevented reliably.

### <Fixing Unit>

The fixing unit 20 includes a fixing drum 84, a halogen heater 86, a fixing roller 88, and an inline sensor 90. The halogen heater 86, the fixing roller 88, and the inline sensor 90 are arranged in positions opposite the outer circumferential surface of the fixing drum 84 in this order from the upstream side in the rotation direction (counterclockwise direction in FIG. 1) of the fixing drum 84.

The fixing drum 84 a drum that holds the recording medium 24 on the outer circumferential surface thereof and rotationally conveys the recording medium 24. The rotation of the fixing drum 84 is driven and controlled by the below-described motor driver 176 (see FIG. 11). The fixing drum 84 has a hook-shaped holding device, and the leading end of the recording medium 24 can be held by this holding device. The recording medium 24 is rotationally conveyed by rotating the fixing drum 84 in a state in which the leading end of the recording medium 24 is held by the holding device. In this case, the recording medium 24 is conveyed in a state where the recording surface thereof faces outward, and the preheating by the halogen heater 86, the fixing treatment by the fixing roller 88 and the inspection by the inline sensor 90 are performed with respect to the recording surface. The fixing drum 84 may be provided with suction apertures on the outer circumferential surface thereof and connected to a suction device that performs suction from the suction apertures. As a result, the recording medium 24 can be held in a state of tight adherence to the outer circumferential surface of the fixing drum 84.

The halogen heater 86 is controlled to a prescribed temperature, by which the preheating is performed with respect to the recording medium 24.

The fixing roller 88 is a roller member which applies heat and pressure to the dried ink to melt and fix the self-dispersible polymer particles in the ink so as to transform the ink into the film. More specifically, the fixing roller 88 is arranged so as to be pressed against the fixing drum 84, and a nip roller is configured between the fixing roller 88 and the fixing drum 84. As a result, the recording medium 24 is squeezed between the fixing roller 88 and the fixing drum 84, nipped under a prescribed nip pressure, and subjected to fixing treatment.

Further, the fixing roller 88 is configured by a heating roller in which a halogen lamp is incorporated in a metal pipe, for example made from aluminum, having good thermal conductivity and the rollers are controlled to a prescribed temperature. Where the recording medium 24 is heated with the heating roller, thermal energy not lower than a Tg temperature (glass transition temperature) of a latex included in the ink is applied and latex particles are melted. As a result, fixing is performed by penetration into the projections-recessions of the recording medium 24, the projections-recessions of the image surface are leveled out, and gloss is obtained.

The fixing unit 20 is provided with the single fixing roller 88 in the above-described embodiment; however, it is possible that a plurality of fixing rollers 88 depending on the thickness of image layer and Tg characteristic of latex particles. Furthermore, the surface of the fixing drum 84 may be controlled to a prescribed temperature.

On the other hand, the inline sensor 90 is a measuring device which measures the check pattern, moisture amount, surface temperature, gloss, and the like of the image fixed to the recording medium 24. A CCD sensor or the like can be used for the inline sensor 90.

With the fixing unit 20 of the above-described configuration, the latex particles located within a thin image layer formed in the drying unit 18 are melted by application of heat and pressure by the fixing roller 88. Thus, the latex particles can be reliably fixed to the recording medium 24. In addition, with the fixing unit 20, the fixing drum 84 is structurally separated from other drums. Therefore, the temperature of the fixing unit 20 can be freely set separately from the image formation unit 16 and the drying unit 18.

### <Discharge Unit>

As shown in FIG. 1, the discharge unit 22 is provided after the fixing unit 20. The discharge unit 22 includes a discharge tray 92, and a transfer body 94, a conveying belt 96, and a tension roller 98 are provided between the discharge tray 92 and the fixing drum 84 of the fixing unit 20 so as to face the discharge tray 92 and the fixing drum 84. The recording medium 24 is fed by the transfer body 94 onto the conveying belt 96 and discharged onto the discharge tray 92.

### <Intermediate Conveyance Unit>

The structure of the first intermediate conveyance unit 26 will be described below. The second intermediate conveyance unit 28 and the third intermediate conveyance unit 30 are configured identically to the first intermediate conveyance unit 26 and the explanation thereof will be omitted.

The first intermediate conveyance unit 26 is provided with an intermediate conveyance body 32, which is a drum for receiving the recording medium 24 from a drum of a previous stage, rotationally conveying the recording medium 24, and transferring it to a drum of the subsequent stage, and is mounted to be capable of rotating freely. The intermediate conveyance body 32 is rotated by a motor 188 (not shown in FIG. 1 and shown in FIG. 11), and the rotation thereof is driven and controlled by the below-described motor driver 176 (see FIG. 11). Further, the intermediate conveyance body 32 is provided on the outer circumferential surface thereof with a hook-shaped holding device, by which the leading end of the recording medium 24 can be held. In a state in which the leading end of the recording medium 24 is held by the holding device, the intermediate conveyance body 32 is rotated to rotationally convey the recording medium 24. In this case, the recording medium 24 is conveyed in a state where the recording surface thereof faces inward, whereas the non-recording surface thereof faces outward.

The recording medium 24 conveyed by the first intermediate conveyance unit 26 is transferred to a drum of the subsequent stage (that is, the image formation drum 70). In this case, the transfer of the recording medium 24 is performed by synchronizing the holding device of the intermediate conveyance unit 26 and the holding device (the gripper 102) of the image formation unit 16. The transferred recording medium 24 is held by the image formation drum 70 and rotationally conveyed.

### <Structure of Inkjet Heads>

Next, the structure of the inkjet heads is described. The inkjet heads 72M, 72K, 72C and 72Y for the respective colored inks have the same structure, and a reference numeral 72 is hereinafter designated to any of the inkjet heads (hereinafter also referred to simply as the heads).

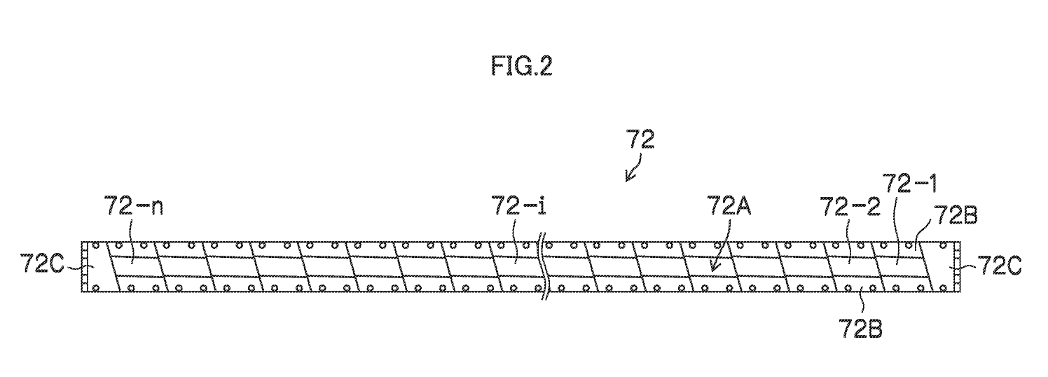

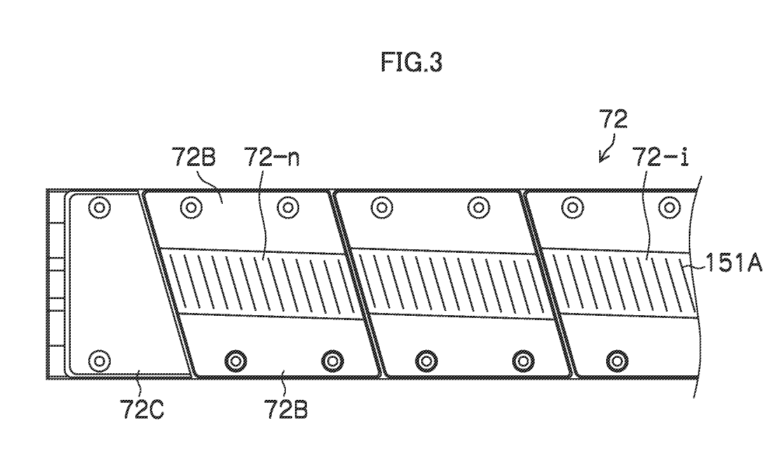

FIG. 2 is a plan diagram showing an embodiment of the structure of the head 72, and depicts the head 72 as viewed from the side of the nozzle surface 72A. FIG. 3 is a partial enlarged diagram of FIG. 2.

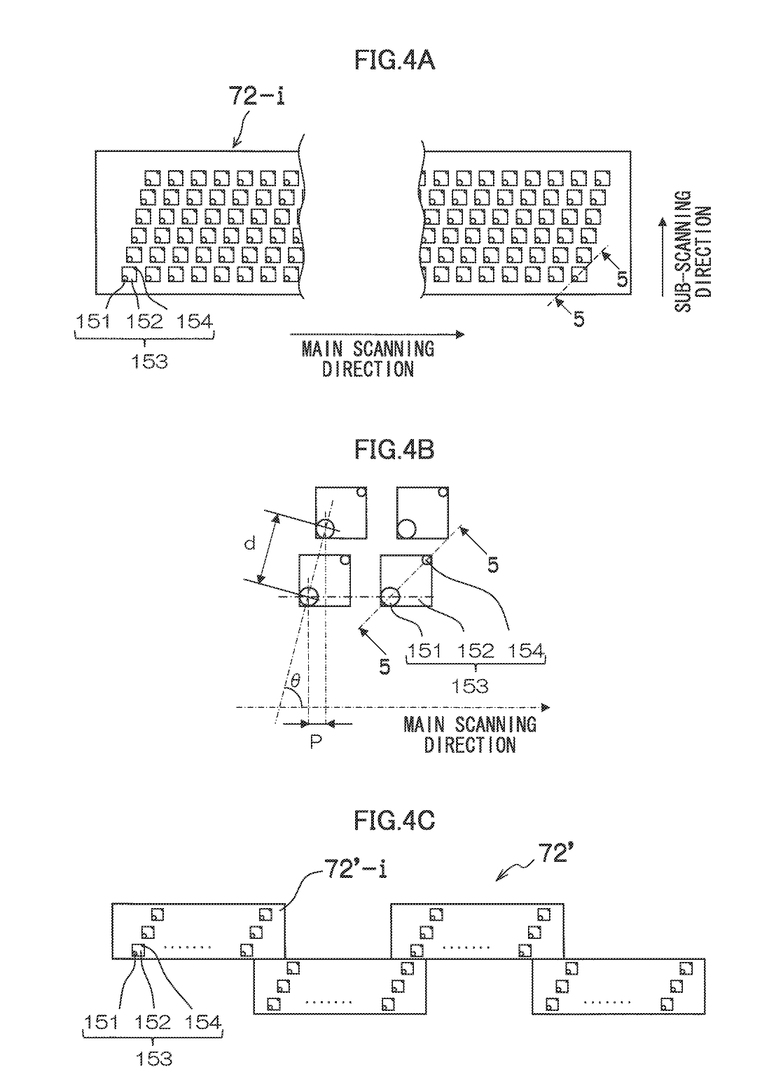

As shown in FIG. 2, the head 72 has a structure in which n head modules 72-i (i=1, 2, 3, . . . , n) are joined together in the lengthwise direction (the direction perpendicular to the direction of conveyance of the recording medium 24 (see FIG. 1)), and a plurality of nozzles 151 (not shown in FIG. 2, and shown in FIGS. 4A to 4C) are arranged through a length corresponding to the full width of the recording medium 24.

The head modules 72-i are supported by head module supporting members 72B from either side in the breadthways direction of the head 72. Furthermore, the end portions of the head 72 in the lengthwise direction are supported by head supporting members 72C.

As shown in FIG. 3, each head module 72-i (n-th head module 72-n) has a structure in which the nozzles 151 (not shown in FIG. 3, and shown in FIGS. 4A to 4C) are arranged in a matrix configuration. In FIG. 3, the oblique solid lines denoted with reference numeral 151A represent the nozzle columns in which the nozzles are arranged in one column.

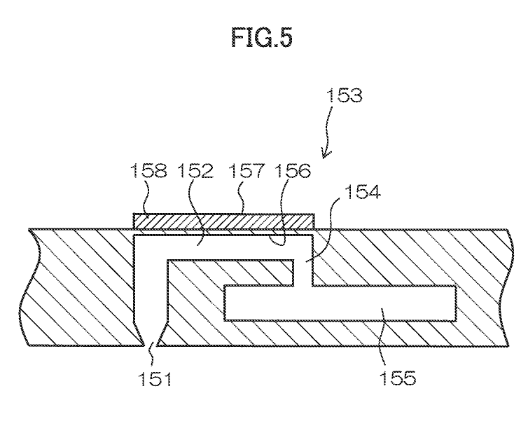

FIG. 4A is a perspective plan view showing an embodiment of the configuration of the head module 72-i, FIG. 4B is an enlarged view of a portion thereof, and FIG. 4C is a perspective plan view showing another embodiment of the configuration of the head 72. FIG. 5 is a cross-sectional view taken along the line 5-5 in FIGS. 4A and 4B, showing the inner structure of an ink chamber unit in the head module 72-i.

The nozzle pitch in the head 72 should be minimized in order to maximize the density of the dots printed on the surface of the recording medium 24. As shown in FIGS. 4A and 4B, the head module 72-i according to the present embodiment has a structure in which a plurality of ink chamber units (i.e., droplet ejection units serving as recording units) 153, each having a nozzle 151 forming an ink ejection aperture, a pressure chamber 152 corresponding to the nozzle 151, and the like, are disposed two-dimensionally in the form of a staggered matrix, and hence the effective nozzle interval (the projected nozzle pitch) as projected in the lengthwise direction of the head 150 (the main scanning direction: the direction perpendicular to the conveyance direction of the recording medium 24) is reduced and high nozzle density is achieved.

The mode of forming one or more nozzle rows through a length corresponding to the entire width of the recording medium 24 in the main scanning direction substantially perpendicular to the conveyance direction of the recording medium 24 (the sub-scanning direction) is not limited to the embodiment described above. For example, instead of the configuration in FIG. 4A, as shown in FIG. 4C, a line head 72′ having nozzle rows of a length corresponding to the entire width of the recording medium 24 can be formed by arranging and combining, in a staggered matrix, short head blocks 72′-i having a plurality of nozzles 151 arrayed in a two-dimensional fashion.

The planar shape of the pressure chamber 152 provided for each nozzle 151 is substantially a square, and the nozzle 151 and an ink supply port 154 are disposed in both corners on a diagonal line of the square. The shape of the pressure chamber 152 is not limited to that of the present embodiment, and a variety of planar shapes, for example, a polygon such as a rectangle (rhomb, rectangle, etc.), a pentagon and a heptagon, a circle, and an ellipse can be employed.

As shown in FIG. 5, each pressure chamber 152 is connected to a common channel 155 through the supply port 154. The common channel 155 is connected to an ink tank (not shown), which is a base tank for supplying ink, and the ink supplied from the ink tank is delivered through the common flow channel 155 to the pressure chambers 152.

A piezoelectric element 158 provided with an individual electrode 157 is bonded to a diaphragm 156, which forms a face (the upper face in FIG. 5) of the pressure chamber 152 and also serves as a common electrode. When a drive voltage is applied to the individual electrode 157, the piezoelectric element 158 is deformed, the volume of the pressure chamber 152 is thereby changed, and the ink is ejected from the nozzle 151 by the variation in pressure that follows the variation in volume. When the piezoelectric element 158 returns to the original state after the ink has been ejected, the pressure chamber 152 is refilled with new ink from the common channel 155 through the supply port 154.

The present embodiment applies the piezoelectric elements 158 as ejection power generation devices to eject the ink from the nozzles 151 arranged in the head 72; however, instead, a thermal system that has heaters within the pressure chambers 152 to eject the ink using the pressure resulting from film boiling by the heat of the heaters can be applied.

As shown in FIG. 4B, the high-density nozzle head according to the present embodiment is achieved by arranging the plurality of ink chamber units 153 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which the ink chamber units 153 are arranged at a uniform pitch d in line with a direction forming the angle of θ with respect to the main scanning direction, the pitch P of the nozzles projected so as to align in the main scanning direction is d×cos θ, and hence the nozzles 151 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the embodiments shown in the drawings, and it is also possible to apply various other types of nozzle arrangements, such as an arrangement structure having one nozzle row in the sub-scanning direction.

Furthermore, the scope of application of the present invention is not limited to a printing system based on the line type of head, and it is also possible to adopt a serial system where a short head that is shorter than the breadthways dimension of the recording medium 24 is moved in the breadthways direction (main scanning direction) of the recording medium 24, thereby performing printing in the breadthways direction, and when one printing action in the breadthways direction has been completed, the recording medium 24 is moved through a prescribed amount in the sub-scanning direction perpendicular to the breadthways direction, printing in the breadthways direction of the recording medium 24 is carried out in the next printing region, and by repeating this sequence, printing is performed over the whole surface of the printing region of the recording medium 24.

### Description of Maintenance Unit

FIG. 6 is a perspective diagram of the maintenance processing unit 199 arranged adjacently to the print unit 16. As shown in FIG. 5, the maintenance processing unit 199 for carrying out maintenance processing of the inkjet heads 72M, 72K, 72C and 72Y is arranged on the outside of the image formation drum 70 of the print unit 16, adjacently to the image formation drum 70 in the axial direction of the image formation drum 70.

The maintenance processing unit 199 is provided with the cleaning processing unit 160, a wiping unit 274 and a nozzle cap 276 disposed in this order from the side near the image formation drum 70.

A head unit 280 mounted with ink droplet ejection heads 72M, 72K, 72C and 72Y corresponding to the respective colors is engaged to a ball screw 284, which is disposed in parallel with the rotational axle 282 of the image formation drum 70. A guide shaft 284G is disposed in parallel with the ball screw 284, on the lower side of the ball screw 284, and the head unit 280 engages slidably with this guide shaft 284G. A guide rail member 286 having guide grooves 286A, which guide the movement of the head unit 280, is disposed in parallel with the ball screw 284, on the lower side of the head unit 280.

The head unit 280 has a frame body 288, which integrally holds the inkjet heads 72M, 72K, 72C and 72Y. Engaging parts (not shown) are projectingly formed on the lower surface of the frame body 288, and slidably engage with the guide grooves 286A, whereby the head unit 280 is able to move by being guided by the guide grooves 286A.

As shown in FIG. 6, the ball screw 284, the guide shaft 284G and the guide rail member 286 are arranged extending in the axial direction of the image formation drum 70 through a prescribed length, in such a manner that the head unit 280 can be moved from an image forming position P1 above the image formation drum 70 to a maintenance position P2 facing the nozzle cap 276.

The ball screw 284 is rotated by a drive device such as a motor (not shown), and due to this rotation, the head unit 280 is moved between the image forming position P1 and the maintenance position P2. Furthermore, the head unit 280 can be moved in a direction away from the image formation drum 70 or in a direction toward the image formation drum 70, by means of an upward/downward movement mechanism (not shown).

The height of the head unit 280 with respect to the surface of the image formation drum 70 (namely, the clearance between the recording surface of the recording medium 24 and the respective inkjet heads 72M, 72K, 72C and 72Y) is controlled in accordance with the thickness of the recording medium 24 used. Furthermore, if a jam, or the like, occurs during conveyance of the recording medium, then the head unit 280 can be moved upward in FIG. 6 and thereby withdrawn from the prescribed height position during image formation.

As shown in FIG. 6, a coupling portion 289 between the frame body 288 of the head unit 280 and the ball screw 284 and the guide shaft 284G employs a linearly movable engagement structure 289A, which guides the upward and downward movement of the head unit 280.

### Description of Cleaning Processing Unit

The cleaning processing unit 160 shown in FIG. 6 is hereby described.

### <General Composition of Cleaning Processing Unit>

FIG. 7 is a general schematic drawing of the cleaning processing unit 160, viewed from the breadthways direction (the sub-scanning direction) of a full line type of inkjet head 72, and the direction perpendicular to the sheet of the drawing is the breadthways direction of the inkjet head 72 (the recording medium conveyance direction, the sub-scanning direction).

The cleaning processing unit 160 includes: a cleaning liquid application unit 162, which forms a pillar of cleaning liquid (cleaning liquid coating layer) 161; a cleaning liquid tank 163, which stores the cleaning liquid to be supplied to the cleaning liquid application unit 162; a cleaning liquid pump 164, which applies pressure to the cleaning liquid inside the cleaning liquid application unit 162; and a recovery tray 169, which recovers the cleaning liquid that has dropped down from the head 72 or the cleaning liquid application unit 162.

The cleaning liquid application unit 162 according to the present embodiment is composed so as to form a cleaning liquid pillar 161 having a uniform height H by emitting a slight amount of the cleaning liquid from a cleaning liquid emission surface 162A, as well as applying the cleaning liquid to the nozzle surface 72A of the head 72 by bringing the cleaning liquid pillar 161 into contact with the nozzle surface 72A.

By moving the head 72 in the lengthwise direction (the lateral direction in FIG. 7) while maintaining a state where the cleaning liquid pillar 161 of the cleaning liquid application unit 162 is in contact with the nozzle surface 72A, the cleaning liquid is applied over the whole of the nozzle surface 72A of the head 72.

When the cleaning liquid pump 164 is driven and a small amount of the cleaning liquid is supplied from the cleaning liquid tank 163 to the cleaning liquid application unit 162, then the cleaning liquid pillar 161 is formed on the cleaning liquid emission surface 162A. By adjusting the flow speed of the cleaning liquid by controlling the output (driving speed) of the cleaning liquid pump 164, it is possible to control the height of the cleaning liquid pillar 161. Therefore, by making the height of the cleaning liquid pillar 161 slightly greater than the interval between the cleaning liquid application unit 162 and the nozzle surface 72A of the head 72, it is possible to achieve stable application of the cleaning liquid corresponding to the overlapped volume, by means of a non-contact method. By suitably adjusting the height H of the cleaning liquid pillar 161, it is possible to adjust the volume of the cleaning liquid applied to the nozzle surface 72A. The height H of the cleaning liquid pillar 161 is appropriately specified in accordance with the properties (e.g., viscosity, surface tension) of the cleaning liquid, and the speed of movement of the head 72, and the like.

The interval between the nozzle surface 72A of the head 72 and the cleaning liquid emission surface 162A of the cleaning liquid application unit 162 is specified in such a manner that the cleaning liquid emission surface 162A and the nozzle surface 72A do not make contact with each other and the interval is set to be less than the maximum value of the height H of the cleaning liquid pillar 161; for example, a mode is possible where the interval is set to approximately 1 mm to 2 mm, for example.

The liquid employed for the cleaning liquid is a special liquid having a high cleaning effect, which has properties for dissolving solidified ink adhering to the nozzle surface 72A, and properties for forming the cleaning liquid pillar 161 on the cleaning liquid emission surface 162A. For example, it is possible to use a cleaning liquid containing a solvent, such as DEGmBE (diethylene glycol monobutyl ether) as the cleaning liquid.

FIG. 8 is a plan diagram of the cleaning liquid emission surface 162A in which the cleaning liquid application unit 162 is viewed from the head 72 side. As shown in FIG. 8, a plurality of cleaning liquid nozzles 165, which emit the cleaning liquid, are disposed at a uniform arrangement pitch of Pₙ on the cleaning liquid emission surface 162A. The dimension D of the cleaning liquid application unit 162 in the lengthwise direction thereof corresponds to the dimension of the head 72 in the breadthways direction thereof (see FIG. 7), and the length through which the cleaning liquid nozzles 165 are arranged is equal to or greater than the dimension of the head 72 in the breadthways direction thereof.

By moving the head 72 just once in the lengthwise direction of the head 72 with respect to the cleaning liquid application unit 162 having the above-described structure, the cleaning liquid is applied over the whole of the nozzle surface 72A of the head 72.

The dimension W of the cleaning liquid application unit 162 in the breadthways direction thereof is specified in accordance with the arrangement pattern of the cleaning liquid nozzles 165. FIG. 8 shows the embodiment of a mode where the cleaning liquid nozzles 165 are arranged in a direction substantially parallel to the lengthwise direction of the cleaning liquid application unit 162 (the breadthways direction of the head 72); however, the direction of arrangement of the cleaning liquid nozzles 165 may also be an oblique direction which forms a prescribed angle with respect to the lengthwise direction of the cleaning liquid application unit 162. Furthermore, the cleaning liquid nozzles 165 may also be arranged over two or more columns.

The arrangement pitch Pₙ of the cleaning liquid nozzles 165 is specified in such a manner that the cleaning liquid emitted from adjacent cleaning liquid nozzles 165 makes contact and combines together. In other words, the cleaning liquid emitted and caused to spread out from each of the cleaning liquid nozzles 165 joins together with the cleaning liquid emitted from the adjacent cleaning liquid nozzle 165, and the cleaning liquid pillar 161 which is connected to the cleaning liquid inside the cleaning liquid nozzles 165 and which has the dimension corresponding to the breadthways-direction dimension of the head 72 is formed. When the top end portion of the cleaning liquid pillar 161 makes contact with the nozzle surface 72A, the surface free energy of the nozzle surface 72A acts in such a manner that a part of the top end portion of the cleaning liquid pillar 161 separates off and adheres to the nozzle surface 72A.

Examples of the dimensions of the cleaning liquid application unit 162 are as follows: the diameter of the cleaning liquid nozzles 165 is 1 mm; the arrangement pitch Pₙ of the cleaning liquid nozzles 165 is 2 mm; and the width W of the cleaning liquid application unit 162 is 4 mm. For example, if sixteen (16) cleaning liquid nozzles of the 1 mm diameter are arranged at the uniform pitch of 2 mm, then the dimension D of the cleaning liquid application unit 162 in the lengthwise direction thereof is approximately 50 mm.

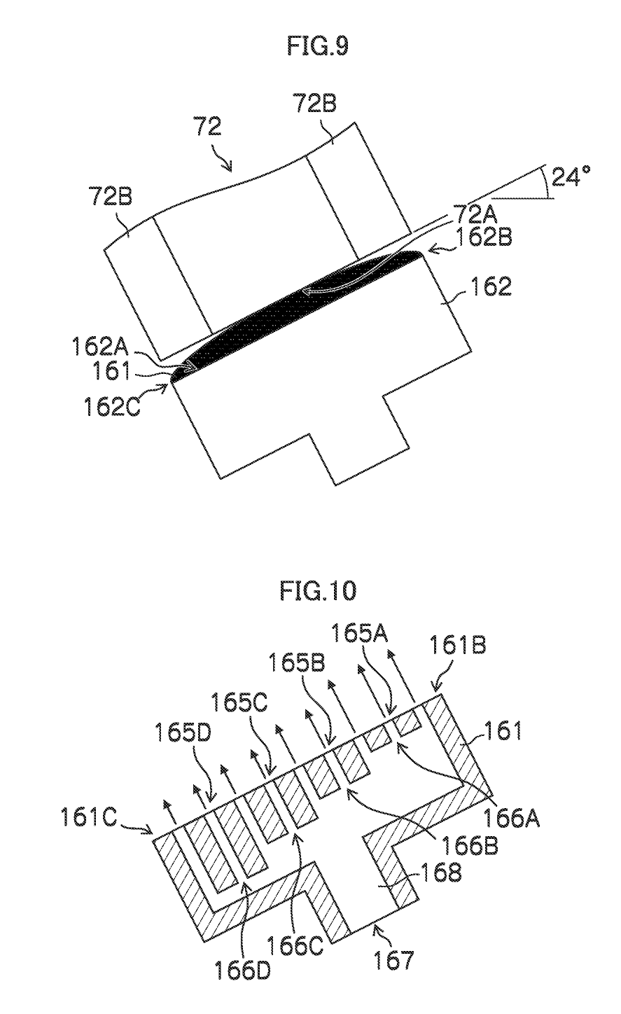

FIG. 9 is a diagram of the head 72 and the cleaning liquid application unit 162 viewed in the breadthways direction of the head 72. The direction perpendicular to the sheet of the drawing in FIG. 9 is the lengthwise direction of the head 72. As shown in FIG. 9, the head 72 is arranged in such a manner that the nozzle surface 72A is inclined to form an angle of approximately 24° with respect to the horizontal plane. Furthermore, the cleaning liquid application unit 162 is arranged with an inclination in such a manner that the cleaning liquid emission surface 162A is substantially parallel to the nozzle surface 72A.

The cleaning liquid application unit 162 in the present embodiment cancels out the pressure differentials inside the cleaning liquid nozzles 165 (see FIG. 8) which occurs between the upper side and the lower side of the cleaning liquid emission surface 162A oblique to the horizontal plane, by means of a flow channel structure, which connects to the cleaning liquid nozzles 165, and forms the cleaning liquid pillar 161 having the substantially uniform height H (see FIG. 7) on the inclined cleaning liquid emission surface 162A.

### <Internal Flow Channel Structure of Cleaning Liquid Application Unit>

Next, the structure of the internal flow channels of the cleaning liquid application unit 162 will be described.

FIG. 10 is a cross-sectional diagram showing a schematic view of the flow channel structure of the cleaning liquid application unit 162. As shown in FIG. 10, the cleaning liquid nozzles 165 (165A to 165D) are connected to a main flow channel 168 through individual flow channels 166 (166A to 166D), and the main flow channel 168 is connected to an inlet port 167.

The individual flow channel 166A, which is connected to the cleaning liquid nozzle 165A arranged in the upper side end portion of the inclined cleaning liquid emission surface 162A, has a shorter flow channel length than the individual flow channel 166B, which is connected to the cleaning liquid nozzle 165B at the lower side of the cleaning liquid nozzle 165A. Similarly, the individual flow channel 166B, which is connected to the cleaning liquid nozzle 165B, has a shorter flow channel length than the individual flow channel 166C, which is connected to the cleaning liquid nozzle 165C at the lower side of the cleaning liquid nozzle 165B. Furthermore, the flow channel length of the individual flow channel 166C, which is connected to the cleaning liquid nozzle 165C, is shorter than the individual flow channel 166D, which is connected to the cleaning liquid nozzle 165D at the lower side of the cleaning liquid nozzle 165C.

More specifically, by making the individual flow channels 166A to 166D, which are connected respectively to the cleaning liquid nozzles 165A to 165D, progressively longer from the upper side to the lower side of the inclined cleaning liquid emission surface 162A, the flow channel resistances of the individual flow channels 166A to 166D, which lead from the inlet port 167 to the respective cleaning liquid nozzles 165A to 165D through the main flow channel 168, become progressively larger from the upper side toward the lower side of the inclination, and the pressure loss on the lower side of the inclination becomes greater than the pressure loss on the upper side of the inclination. This flow channel structure cancels out the pressure differential arising inside the cleaning liquid application unit 162 by means of the differential in the flow channel resistance.

Thus, the flow channel structure inside the cleaning liquid application unit 162 is designed in such a manner that the sum of the differential in pressure loss arising due to the differential in flow channel resistance from the inlet port 167 to each of the cleaning liquid nozzles 165 and the differential in the liquid head pressure in each of the cleaning liquid nozzles 165 arising due to the inclination of the cleaning liquid application unit 162 is constant for every cleaning liquid nozzle 165.

When pressure is applied uniformly to the inside of the above-described flow channel structure from the inlet port 167 of the cleaning liquid application unit 162, the cleaning liquid nozzles 165 on the upper side of the inclination where the liquid head pressure differential is relatively larger (e.g., the cleaning liquid nozzle 165A) have relatively smaller pressure loss due to the flow channel resistance in the individual flow channels 166 connected to those cleaning liquid nozzles 165, whereas the cleaning liquid nozzles 165 on the lower side of the inclination where the liquid head pressure differential is relatively smaller (e.g., any of the cleaning liquid nozzles 165B to 165D) have relatively larger pressure loss due to the flow channel resistance in the individual flow channels 166 connected to those cleaning liquid nozzles 165.

The cleaning liquid application unit 162 having the flow channel structure described above is equivalent to making the pressure on the upper side of the inclined cleaning liquid emission surface 162A (the side having smaller pressure loss), in which the cleaning liquid nozzles 165 are arranged, greater than the pressure on the lower side of the inclination (the side having greater pressure loss), and hence the pressure is made uniform on the upper side and the lower side of the inclination and the height H of the cleaning liquid pillar 161 formed by emitting the cleaning liquid from the cleaning liquid nozzles 165A to 165D is substantially the same from the upper side through to the lower side of the inclination.

Although FIG. 10 shows the mode where the flow channel resistance is made greater by increasing the flow channel length in four stages (in a stepwise fashion) from the upper side of the inclination to the lower side of the inclination, it is sufficient if the flow channel length (flow channel resistance) is changed in at least two steps, and furthermore, the flow channel resistance may also be increased continuously by increasing the flow channel length continuously from the upper side of the inclination to the lower side of the inclination.

In order to change the flow channel resistance of the individual flow channels 166 connecting to the cleaning liquid nozzles 165, it is also possible to change the diameter of the individual flow channels 166 or to change the internal surface roughness of the individual flow channels 166. In a mode which changes the diameter or the internal surface roughness of the individual flow channels 166, it is sufficient that the diameter or internal surface roughness is changed in at least a portion of the individual flow channels 166. The flow channel resistance may also be changed by appropriately combining change of the length, diameter and surface roughness of the individual flow channels 166.

### Description of Control System

FIG. 11 is a block diagram of the main portion of a system configuration of the inkjet recording apparatus 10. The inkjet recording apparatus 10 includes a communication interface 170, a system controller 172, a memory 174, the motor driver 176, a heater driver 178, a maintenance control unit 179, a printing control unit 180, an image buffer memory 182, a head driver 184, a sensor 185, a program storage unit 190, a treatment liquid application control unit 196, a drying control unit 197, and a fixing control unit 198.

The communication interface 170 is an interface unit that receives image data sent from a host computer 186. A serial interface such as USB (Universal Serial Bus), IEEE 1394, Ethernet, and a wireless network, or a parallel interface such as Centronix can be applied as the communication interface 170. A buffer memory (not shown) may be installed in the part of the interface to increase the communication speed. The image data sent from the host computer 186 are introduced into the inkjet recording apparatus 10 through the communication interface 170 and temporarily stored in the memory 174.

The memory 174 is a storage device that temporarily stores the images inputted through the communication interface 170 and reads/writes the data via the system controller 172. The memory 174 is not limited to a memory composed of semiconductor elements and may use a magnetic medium such as a hard disk.

The system controller 172 includes a central processing unit (CPU) and a peripheral circuitry thereof, functions as a control device that controls the entire inkjet recording apparatus 10 according to a predetermined program, and also functions as an operational unit that performs various computations. Thus, the system controller 172 controls various units such as the communication interface 170, the memory 174, the motor driver 176, the heater driver 178, the maintenance control unit 179, the treatment liquid application control unit 196, the drying control unit 197 and the fixing control unit 198, performs communication control with the host computer 180, performs read/write control of the memory 174, and also generates control signals for controlling the various units.

Programs that are executed by the CPU of the system controller 172 and various data necessary for performing the control are stored in the memory 174. The memory 174 may be a read-only storage device or may be a writable storage device such as EEPROM. The memory 174 can be also used as a region for temporary storing image data, a program expansion region, and a computational operation region of the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. The program storage unit 190 may be provided with an external interface, and a memory card or PC card may also be used. Naturally, a plurality of these storage media may also be provided. The program storage unit 190 may also be combined with a storage device for storing operational parameters, and the like (not shown).

The motor driver 176 drives a motor 188 in accordance with commands from the system controller 172. In FIG. 11, the plurality of motors disposed in the respective sections of the inkjet recording apparatus 10 are represented by the reference numeral 188. For example, the motor 188 shown in FIG. 11 includes the motors that drive the paper transfer drum 52, the treatment liquid drum 54, the image formation drum 70, the drying drum 76, the fixing drum 84 and the transfer body 94 shown in FIG. 1, and the motors that drive the intermediate conveyance bodies 32 in the first, second and third intermediate conveyance units 26, 28 and 30.

The heater driver 178 is a driver that drives the heater 189 in accordance with commands from the system controller 172. In FIG. 11, the plurality of heaters disposed in the inkjet recording apparatus 10 are represented by the reference numeral 189. For example, the heater 189 shown in FIG. 11 includes the halogen heaters 80 in the solvent dryer 78 arranged in the drying unit 18 shown in FIG. 1, and the heaters that heat the surfaces of the drying drum 76 and the fixing drum 84 shown in FIG. 1.

The treatment liquid application control unit 196, the drying control unit 197 and the fixing control unit 198 control the operations of the treatment liquid application device 56, the solvent dryer 78 and the fixing roller 88, respectively, in accordance with commands from the system controller 172.

The printing control unit 180 has a signal processing function for performing a variety of processing and correction operations for generating signals for print control from the image data within the memory 174 according to control of the system controller 172, and supplies the generated printing data (dot data) to the head driver 184. The required signal processing is implemented in the printing control unit 180, and the ejection amount and ejection timing of droplets in the heads 72 are controlled through the head driver 184 based on the image data. As a result, the desired dot size and dot arrangement are realized.

The printing control unit 180 is provided with the image buffer memory 182, and data such as image data or parameters are temporarily stored in the image buffer memory 182 during image data processing in the printing control unit 180. A mode is also possible in which the printing control unit 180 and the system controller 172 are integrated and configured by one processor.

The head driver 184 generates drive signals for driving the piezoelectric elements 158 of the heads 72, on the basis of the dot data supplied from the print controller 180, and drives the piezoelectric elements 158 by applying the generated drive signals to the piezoelectric elements 158. A feedback control system for maintaining constant drive conditions in the inkjet heads 72 may be included in the head driver 184 shown in FIG. 11.

The sensor 185 represents the sensors disposed in the respective sections of the inkjet recording apparatus 10. For example, the sensor 185 includes the inline sensor 90 shown in FIG. 1, temperature sensors, position determination sensors, and pressure sensors. The output signals of the sensor 185 are sent to the system controller 172, and the system controller 172 controls the respective sections of the inkjet recording apparatus 10 by sending the command signals to the respective sections in accordance with the output signals of the sensor 185.

The maintenance control unit 179 is a processing block that controls the maintenance processing unit 199 (see FIG. 6) including the cleaning processing unit 160 shown in FIGS. 7 to 10, in accordance with control signals supplied from the system controller 172. Furthermore, the maintenance control unit 179 has a function for sending, to the respective units, control signals relating to the implementation of maintenance processing, such as preliminary ejection, suction, or the like, for expelling degraded ink inside the nozzles to the exterior of the heads 72.

Although the detailed composition of the maintenance control unit 179 is not shown, the maintenance control unit 179 controls the movement timing and the movement speed of the head 72 in the processing region of the cleaning processing section 160, in accordance with control signals from the system controller 172, as well as controlling the drive speed of the cleaning liquid pump 164 (flow speed of the cleaning liquid), the driving of conveyance of a web in the wiping unit 274, the elevator mechanism of the web, and the like.

More specifically, the maintenance control unit 179 controls the maintenance processing unit 199 in such a manner that maintenance of the head 72 (the cleaning process of the nozzle surface 72A) is carried out in the following sequence. Firstly, the head 72 is moved to the processing region of the maintenance processing unit 199. Thereupon, the cleaning liquid application unit 162 is moved in the vertical direction and the distance between the cleaning liquid emission surface 162A (see FIG. 7) and the nozzle surface 72A is thereby adjusted.

When the head 72 and the cleaning liquid application unit 162 have been registered in position, the cleaning liquid pillar 161 (see FIG. 7) having the prescribed height H is produced from the cleaning liquid nozzles 165 and the top end of the cleaning liquid pillar 161 is made to contact the nozzle surface 72A. The head 72 is moved in the lengthwise direction thereof while maintaining a state where the cleaning liquid pillar 161 is in contact with the nozzle surface 72A, thereby applying the cleaning liquid to the whole of the nozzle surface 72A.

When a prescribed time period has elapsed after the application of the cleaning liquid to the whole of the nozzle surface 72A, the head 72 is moved to the processing region of the wiping unit 274, and the cleaning liquid on the nozzle surface 72A is wiped away by the wiping unit 274. Then, the head 72 is moved to the processing region of the nozzle cap 276 and preliminary ejection is performed from the head 72. After completing the maintenance processing of the head 72, the head 72 is moved to the prescribed image formation position.

In the inkjet recording apparatus having the heads 72M, 72K, 72C and 72Y as shown in FIG. 1, it is possible to adopt a composition in which the cleaning processing units 160 are provided in equal number to the heads 72M, 72K, 72C and 72Y (namely, respectively for the heads 72M, 72K, 72C and 72Y), and a cleaning process is carried out simultaneously in all of the heads 72M, 72K, 72C and 72Y, or a composition in which number of the cleaning processing units 160 fewer than the heads 72M, 72K, 72C and 72Y are moved successively so as to progressively carry out the cleaning process of all of the heads 72M, 72K, 72C and 72Y.

In a mode where the number of cleaning processing units 160 used is smaller than the number of heads 72M, 72K, 72C and 72Y, the inkjet recording apparatus is provided with a function for changing the inclination of the cleaning liquid emission surface 162A or the inclination of the cleaning liquid application unit 162 correspondingly to the inclination of each of the heads 72M, 72K, 72C and 72Y.

According to the cleaning processing unit 160 having the above-described composition, since the flow channels of the cleaning liquid application unit 162 (the individual flow channels 166 and the main flow channel 168) are composed in such a manner that the pressure loss on the upper side of the inclination of the cleaning liquid emission surface 162A is less than the lower side of the inclination, when the cleaning liquid pillar 161 is produced from the cleaning liquid emission surface 162A that is inclined so as to be substantially parallel with the nozzle surface 72A that is oblique to the horizontal plane, and the top end portion of the cleaning liquid pillar 161 is made to contact the nozzle surface 72A, thereby applying the cleaning liquid to the nozzle surface 72A in the non-contact fashion, then the pressure differential generated inside the cleaning liquid application unit 162 due to the inclined attitude is cancelled out by the differential in the pressure loss due to the flow channel structure, and the cleaning liquid pillar 161 of a substantially uniform height H is formed.

### Modified Embodiments

Next, modifications of the aforementioned embodiment will be described.

### First Modified Embodiment

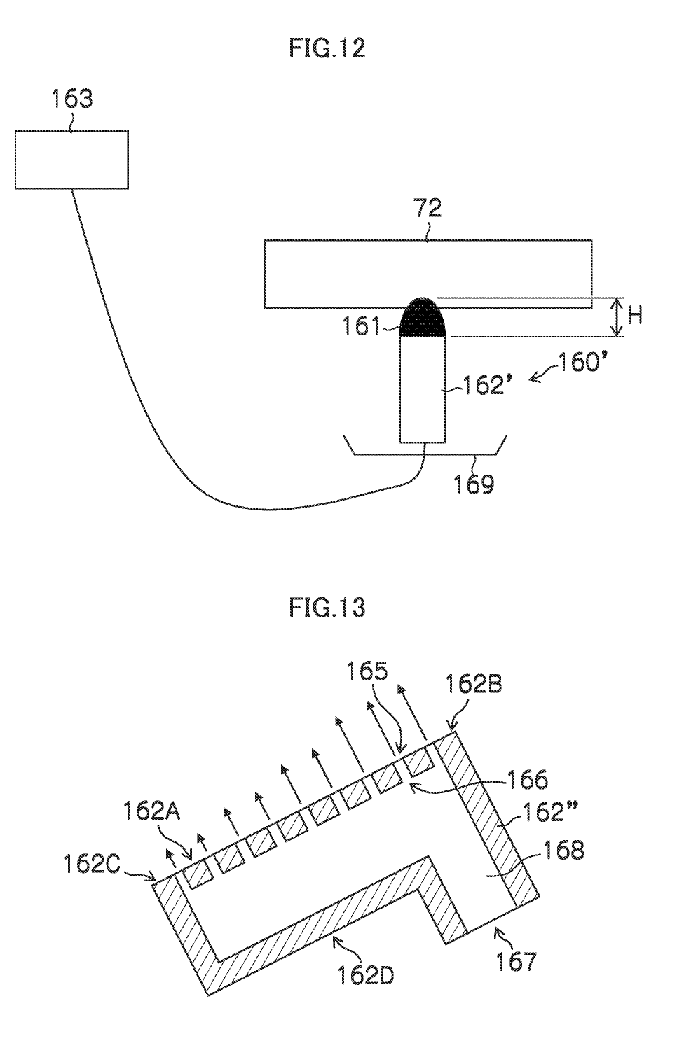

FIG. 12 is a schematic drawing of a cleaning processing unit 160′ according to a first modified embodiment.

In the composition of the cleaning processing unit 160 shown in FIG. 7, slight pulsation occurs in the cleaning liquid pillar 161 due to the cleaning liquid pump 164. In cases of this kind, it is possible to eliminate the pulsation of the cleaning liquid pillar 161 by installing a damper in the supply channel (not illustrated) of the cleaning liquid.

In order to achieve more stable application of the cleaning liquid, it is also possible to achieve stable application of the cleaning liquid by adjusting the flow speed of the cleaning liquid using a liquid head pressure differential, instead of adjusting the flow speed of the cleaning liquid by means of the pump.

FIG. 12 is a schematic diagram of a head cleaning unit 160′ (cleaning liquid application unit 162′) employing a method that adjusts the flow speed of the cleaning liquid by using the liquid head pressure differential. In FIG. 12, parts which are the same as or similar to FIGS. 7 to 11 are denoted with the same reference numerals and further explanation thereof is omitted here.

The head cleaning unit 160′ in FIG. 12 has a mechanism (not shown) for altering the height (liquid head differential h) of the cleaning liquid tank 163 with respect to the cleaning liquid application unit 162′, and the flow speed of the cleaning liquid is regulated by altering the liquid head pressure differential of the cleaning liquid tank 163 with respect to the cleaning liquid pillar generation unit 162′.

According to the first modified embodiment, destabilization of the height H of the cleaning liquid pillar 161 due to pulsation caused by the cleaning liquid pump 164 is avoided, and the cleaning liquid can be applied uniformly to the nozzle surface 72A.

### Second Modified Embodiment

FIG. 13 is a cross-sectional diagram showing the structure of a cleaning liquid application unit 162″ according to a second modified embodiment. In the cleaning liquid application unit 162″ shown in FIG. 13, the inlet port 167 is provided in the uppermost portion of the inclination of the bottom face 162D, which is opposite to the cleaning liquid emission surface 162A.

More specifically, by arranging the inlet port 167 nearer to the cleaning liquid nozzles 165 on the upper side of the inclination and arranging the inlet portion 167 further from the cleaning liquid nozzles 165 on the lower side of the inclination, a pressure differential is produced that cancels out the pressure differential (liquid head pressure differential) arising due to the inclination between the cleaning liquid nozzles 165 on the upper side of the inclination and the cleaning liquid nozzles 165 on the lower side of the inclination.

According to this structure, the pressure applied by the cleaning liquid that flows in from the inlet port 167 is transmitted directly to the cleaning liquid nozzle 165 on the upper side of the inclination, thereby cancelling out the pressure differential produced inside the cleaning liquid application unit 162″.

### Third Modified Embodiment

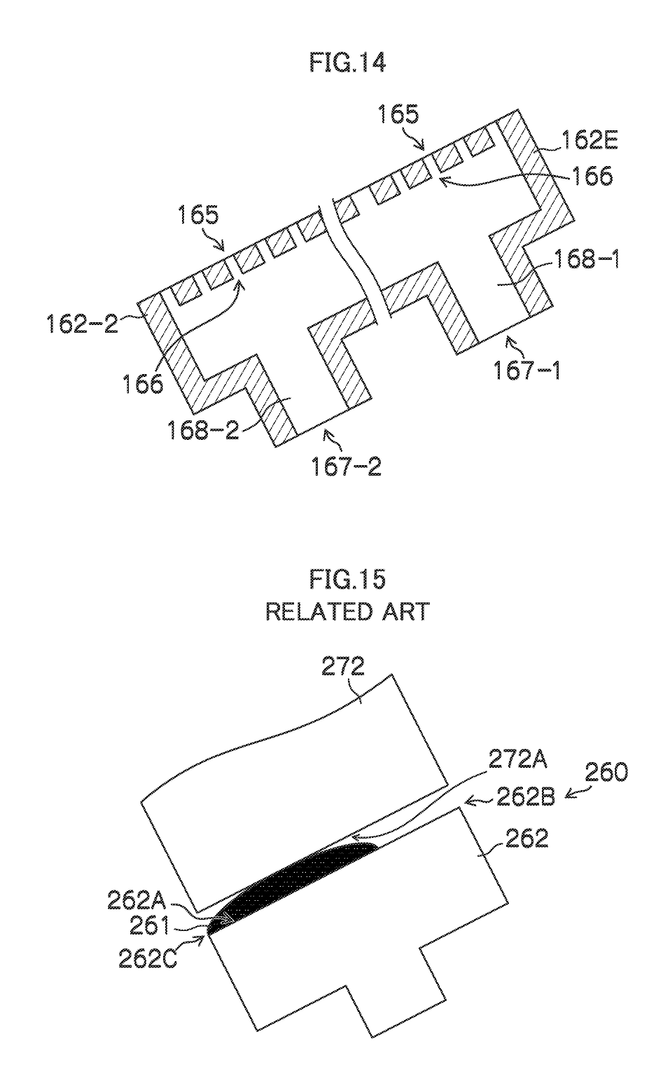

FIG. 14 is a schematic drawing of a cleaning liquid application unit 162E according to a third modified embodiment. The cleaning liquid application unit 162E shown in FIG. 14 has a structure which is internally divided into two parts, and the divided parts are provided respectively with inlet ports 167-1 and 167-2. More specifically, the cleaning liquid application unit 162E has a structure in which a cleaning liquid application unit 162-1 on the upper side of the inclination and a cleaning liquid application unit 162-2 on the lower side of the inclination are integrally composed, in such a manner that pressure can be applied independently to the units through the inlet ports 167-1 and 167-2. For example, it is possible that the inlet ports 167-1 and 167-2 are connected respectively to first and second cleaning liquid pumps, which are independently controlled.

By making the applied pressure to the cleaning liquid application unit 162-1 on the upper side of the inclination greater than the applied pressure to the cleaning liquid application unit 162-2 on the lower side of the inclination, it is possible to adjust the height of the cleaning liquid pillar 161 (see FIG. 7) to a substantially uniform height.

In the present embodiments, the mode has been described in which the maintenance processing unit 199 is appended to the inkjet recording apparatus 10; however, it is also possible to compose a maintenance apparatus for the inkjet head by separating the maintenance processing unit 199 from the inkjet recording apparatus 10.

Moreover, it may also be composed as a processing apparatus which has the respective functions of the cleaning processing unit 160, the wiping unit 274 and the nozzle cap 276, which compose the maintenance processing unit 199.

Furthermore, in the present embodiments, the inkjet recording apparatus has been described which records a color image by ejecting and depositing color inks onto a recording medium as one example of an image forming apparatus; however, the present invention can also be applied to an image forming apparatus which forms a prescribed pattern shape on a substrate by means of a resin liquid, or the like, in order, for instance, to form a mask pattern or to print wiring of a printed wiring board.

### APPENDIX

As has become evident from the detailed description of the embodiments given above, the present specification includes disclosure of various technical ideas below.

It is preferable that an inkjet head cleaning apparatus comprises: a plurality of cleaning liquid nozzles through which cleaning liquid is applied to a liquid ejection surface of an inkjet head in which the liquid ejection surface is oblique to a horizontal plane, the cleaning liquid nozzles being arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface; a plurality of flow channels which are connected respectively to the cleaning liquid nozzles; a cleaning liquid inlet port through which the cleaning liquid is supplied to the cleaning liquid nozzles through the flow channels; and a pressure application device which applies pressure to the cleaning liquid to be emitted through the cleaning liquid nozzles, wherein the pressure applied by the pressure application device to the cleaning liquid supplied to the cleaning liquid nozzles on an upper side of the inclined cleaning liquid emission surface is greater than the pressure applied by the pressure application device to the cleaning liquid supplied to the cleaning liquid nozzles on a lower side of the inclined cleaning liquid emission surface.

According to this mode, in the cleaning liquid nozzles arranged in substantially the same direction as the inclination of the inkjet head arranged obliquely to the horizontal plane, the pressure difference arising between the cleaning liquid nozzles on the upper side of the inclination and the cleaning liquid nozzles on the lower side of the inclination can be made uniform, and a prescribed amount of the cleaning liquid can be applied stably to the nozzle surface oblique to the horizontal plane.

When the cleaning liquid is supplied to the cleaning liquid nozzles, if the cleaning liquid in the cleaning liquid nozzles is applied with a uniform pressure, then the cleaning liquid emitted from mutually adjacent cleaning liquid nozzles makes contact and combines together, thereby forming a cleaning liquid pillar (cleaning liquid coating layer), which is not separated from the cleaning liquid inside the cleaning liquid nozzles, on the cleaning liquid emission surface.

The flow channels connected to the cleaning liquid nozzles may include a common flow channel which connects to the inlet port and individual flow channels which branch from the common flow channel and connect to the cleaning liquid nozzles.

The inkjet head is a liquid ejection head which ejects liquid from nozzles (apertures) arranged in the liquid ejection surface, using an inkjet method, and one embodiment of the composition of such a head includes liquid chambers connected to the nozzles and pressure applying devices which apply pressure to the liquid inside the liquid chambers. Furthermore, the liquid to be ejected from the inkjet head includes various liquids, such as color inks which form (record) an image on a recording medium, or a resin liquid which forms a prescribed pattern on a substrate, or the like.

Preferably, a flow channel resistance from the inlet port to one of the cleaning liquid nozzles on the upper side of the inclined cleaning liquid emission surface is smaller than a flow channel resistance from the inlet port to one of the cleaning liquid nozzles on the lower side of the inclined cleaning liquid emission surface.

According to this mode, it is possible to make the pressure loss in the cleaning liquid nozzles positioned on the upper side of the inclination smaller than the pressure loss in the cleaning liquid nozzles positioned on the lower side of the inclination, thereby cancelling out the pressure differential generated by the inclination, and the pressure distribution occurring between the upper and lower sides of the inclination on the cleaning liquid emission surface becomes uniform.

In order to change the flow channel resistance, it is possible to alter the cross-sectional area of the flow channel or to alter the internal surface roughness of the flow channel (e.g., by the internal processing or by changing material of the flow channels). Furthermore, it is also possible to adopt a mode which arranges a restricting member inside the flow channels.

Preferably, a flow channel resistance from the inlet port to each of the cleaning liquid nozzles successively increases from one of the cleaning liquid nozzle on the upper side of the inclined cleaning liquid emission surface toward one of the cleaning liquid nozzles on the lower side of the inclined cleaning liquid emission surface, such that the cleaning liquid nozzles have a uniform pressure distribution.

According to this mode, the pressure loss progressively becomes smaller from the cleaning liquid nozzles positioned on the upper side of the inclination to the cleaning liquid nozzles positioned on the lower side of the inclination, and a uniform pressure is applied to all of the cleaning liquid nozzles, from the upper side of the inclination to the lower side of the inclination.

Preferably, the inlet port is arranged nearer to the upper side of the inclined cleaning liquid emission surface than the lower side of the inclined cleaning liquid emission surface; and a length of a flow channel from the inlet port to one of the cleaning liquid nozzles on the upper side of the inclined cleaning liquid emission surface is shorter than a length of a flow channel from the inlet port to one of the cleaning liquid nozzles on the lower side of the inclined cleaning liquid emission surface.

According to this mode, it is possible forcibly to cancel out the pressure difference occurring between the cleaning liquid nozzles positioned on the upper side of the inclination and the cleaning liquid nozzles positioned on the lower side of the inclination.

Preferably, the inlet port is arranged nearer to the upper side of the inclined cleaning liquid emission surface than the lower side of the inclined cleaning liquid emission surface; and a length of a flow channel from the inlet port to each of the cleaning liquid nozzles successively increases from one of the cleaning liquid nozzles on the upper side of the inclined cleaning liquid emission surface toward one of the cleaning liquid nozzles on the lower side of the inclined cleaning liquid emission surface, such that the cleaning liquid nozzles have a uniform pressure distribution.

According to this mode, it is possible to apply a uniform pressure and to maintain a uniform height of the cleaning liquid emitted from the cleaning liquid emission surface, from the cleaning liquid nozzles on the upper side of the inclination through the cleaning liquid nozzles on the lower side of the inclination.

Preferably, the cleaning liquid nozzles and the flow channels have a structure whereby a sum of difference in pressure loss caused by a variation in flow channel resistance and difference in liquid head pressure produced by the inclination of the cleaning liquid emission surface is constant.

According to this mode, the height of the cleaning liquid emitted from the cleaning liquid nozzles is uniform from the upper side through the lower side of the inclination, and a uniform cleaning liquid can be applied to the liquid ejection surface of the inkjet head.

Preferably, the apparatus further comprises: a cleaning liquid tank which stores the cleaning liquid to be supplied to the cleaning liquid nozzles; and a vertical movement device which moves the cleaning liquid nozzles and the cleaning liquid tank relatively to each other in a vertical direction, wherein the pressure application device applies the pressure to the cleaning liquid to be emitted from the cleaning liquid nozzles using a liquid head pressure differential between the cleaning liquid nozzles and the cleaning liquid tank.

According to this mode, pulsation of the pressure does not occur in the cleaning liquid nozzles, and the height of the cleaning liquid is uniform at all time.

Preferably, the inlet port includes a first inlet port connected to the cleaning liquid nozzles on the upper side of the inclined cleaning liquid emission surface, and a second inlet port connected to the cleaning liquid nozzles on the lower side of the inclined cleaning liquid emission surface; and the pressure application device includes a first pressure application device which applies the pressure to the cleaning liquid supplied to the cleaning liquid nozzles on the upper side of the inclined cleaning liquid emission surface through the first inlet port, and a second pressure application device which applies the pressure to the cleaning liquid supplied to the cleaning liquid nozzles on the lower side of the inclined cleaning liquid emission surface through the second inlet port.

In this mode, the cleaning liquid nozzles are divided into a first cleaning liquid nozzle group which are connected to the first inlet port and a second cleaning liquid nozzle group which are connected to the second inlet port.

It is also preferable that an image recording apparatus comprises: an inkjet head which has a liquid ejection surface oblique to a horizontal plane; and an inkjet head cleaning unit which applies cleaning liquid to the liquid ejection surface of the inkjet head, wherein the head cleaning unit includes: a plurality of cleaning liquid nozzles through which the cleaning liquid is applied to the liquid ejection surface of the inkjet head, the cleaning liquid nozzles being arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface; a plurality of flow channels which are connected respectively to the cleaning liquid nozzles; a cleaning liquid inlet port through which the cleaning liquid is supplied to the cleaning liquid nozzles through the flow channels; and a pressure application device which applies pressure to the cleaning liquid to be emitted through the cleaning liquid nozzles, wherein the pressure applied by the pressure application device to the cleaning liquid supplied to the cleaning liquid nozzles on an upper side of the inclined cleaning liquid emission surface is greater than the pressure applied by the pressure application device to the cleaning liquid supplied to the cleaning liquid nozzles on a lower side of the inclined cleaning liquid emission surface.

In this mode, a desirable mode is one where a head movement device which moves the inkjet head to the processing region of the inkjet head cleaning unit is provided, and the inkjet head is moved to the processing region of the inkjet head cleaning unit when carrying out a cleaning process of the liquid ejection surface of the inkjet head.

A desirable mode is one where the cleaning liquid is applied over the whole of the liquid ejection surface by moving the inkjet head in the processing region of the inkjet head cleaning unit.

It is also preferable that a method of cleaning an inkjet head having a liquid ejection surface oblique to a horizontal plane, the method comprises the steps of: applying cleaning liquid to the liquid ejection surface by emitting the cleaning liquid from a plurality of cleaning liquid nozzles that are arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface; and adjusting pressure applied to the cleaning liquid supplied to the cleaning liquid nozzles on an upper side of the inclined cleaning liquid emission surface so as to be greater than pressure applied to the cleaning liquid supplied to the cleaning liquid nozzles on a lower side of the inclined cleaning liquid emission surface.

A desirable mode is one further comprising the step of moving the inkjet head to the cleaning processing region, and the step of applying the cleaning liquid to the whole of the liquid ejection surface by moving the inkjet head in the cleaning processing region.

Preferably, the method further comprises the step of wiping away the cleaning liquid having been applied to the liquid ejection surface.

According to this mode, after the cleaning process of the inkjet head, no cleaning liquid is left on the liquid ejection surface.

Desirably, this mode includes the step of moving the inkjet head to a prescribed printing position after the wiping step.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet head cleaning apparatus, comprising:
a plurality of cleaning liquid nozzles through which cleaning liquid is applied to a liquid ejection surface of an inkjet head in which the liquid ejection surface is oblique to a horizontal plane, the cleaning liquid nozzles being arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface;
a plurality of flow channels which are connected respectively to the cleaning liquid nozzles;
a cleaning liquid inlet port through which the cleaning liquid is supplied to the cleaning liquid nozzles through the flow channels; and
a pressure application device which applies pressure to the cleaning liquid to be emitted through the cleaning liquid nozzles,
wherein the pressure applied by the pressure application device to the cleaning liquid supplied to the cleaning liquid nozzles on an upper side of the inclined cleaning liquid emission surface is greater than the pressure applied by the pressure application device to the cleaning liquid supplied to the cleaning liquid nozzles on a lower side of the inclined cleaning liquid emission surface.

2. The apparatus as defined in claim 1, wherein a flow channel resistance from the inlet port to one of the cleaning liquid nozzles on the upper side of the inclined cleaning liquid emission surface is smaller than a flow channel resistance from the inlet port to one of the cleaning liquid nozzles on the lower side of the inclined cleaning liquid emission surface.

3. The apparatus as defined in claim 1, wherein a flow channel resistance from the inlet port to each of the cleaning liquid nozzles successively increases from one of the cleaning liquid nozzle on the upper side of the inclined cleaning liquid emission surface toward one of the cleaning liquid nozzles on the lower side of the inclined cleaning liquid emission surface, such that the cleaning liquid nozzles have a uniform pressure distribution.

4. The apparatus as defined in claim 3, wherein the cleaning liquid nozzles and the flow channels have a structure whereby a sum of difference in pressure loss caused by a variation in the flow channel resistance and difference in liquid head pressure produced by the inclination of the cleaning liquid emission surface is constant.

5. The apparatus as defined in claim 1, wherein:
the inlet port is arranged nearer to the upper side of the inclined cleaning liquid emission surface than the lower side of the inclined cleaning liquid emission surface; and
a length of a flow channel from the inlet port to one of the cleaning liquid nozzles on the upper side of the inclined cleaning liquid emission surface is shorter than a length of a flow channel from the inlet port to one of the cleaning liquid nozzles on the lower side of the inclined cleaning liquid emission surface.

6. The apparatus as defined in claim 1, wherein:
the inlet port is arranged nearer to the upper side of the inclined cleaning liquid emission surface than the lower side of the inclined cleaning liquid emission surface; and
a length of a flow channel from the inlet port to each of the cleaning liquid nozzles successively increases from one of the cleaning liquid nozzles on the upper side of the inclined cleaning liquid emission surface toward one of the cleaning liquid nozzles on the lower side of the inclined cleaning liquid emission surface, such that the cleaning liquid nozzles have a uniform pressure distribution.

7. The apparatus as defined in claim 6, wherein the cleaning liquid nozzles and the flow channels have a structure whereby a sum of difference in pressure loss caused by a variation in flow channel resistance and difference in liquid head pressure produced by the inclination of the cleaning liquid emission surface is constant.

8. The apparatus as defined in claim 1, further comprising:
a cleaning liquid tank which stores the cleaning liquid to be supplied to the cleaning liquid nozzles; and
a vertical movement device which moves the cleaning liquid nozzles and the cleaning liquid tank relatively to each other in a vertical direction,
wherein the pressure application device applies the pressure to the cleaning liquid to be emitted from the cleaning liquid nozzles using a liquid head pressure differential between the cleaning liquid nozzles and the cleaning liquid tank.

9. The apparatus as defined in claim 1, wherein:
the inlet port includes a first inlet port connected to the cleaning liquid nozzles on the upper side of the inclined cleaning liquid emission surface, and a second inlet port connected to the cleaning liquid nozzles on the lower side of the inclined cleaning liquid emission surface; and
the pressure application device includes a first pressure application device which applies the pressure to the cleaning liquid supplied to the cleaning liquid nozzles on the upper side of the inclined cleaning liquid emission surface through the first inlet port, and a second pressure application device which applies the pressure to the cleaning liquid supplied to the cleaning liquid nozzles on the lower side of the inclined cleaning liquid emission surface through the second inlet port.

10. An image recording apparatus, comprising:
an inkjet head which has a liquid ejection surface oblique to a horizontal plane; and
an inkjet head cleaning unit which applies cleaning liquid to the liquid ejection surface of the inkjet head,
wherein the head cleaning unit includes:
a plurality of cleaning liquid nozzles through which the cleaning liquid is applied to the liquid ejection surface of the inkjet head, the cleaning liquid nozzles being arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface;
a plurality of flow channels which are connected respectively to the cleaning liquid nozzles;
a cleaning liquid inlet port through which the cleaning liquid is supplied to the cleaning liquid nozzles through the flow channels; and
a pressure application device which applies pressure to the cleaning liquid to be emitted through the cleaning liquid nozzles,
wherein the pressure applied by the pressure application device to the cleaning liquid supplied to the cleaning liquid nozzles on an upper side of the inclined cleaning liquid emission surface is greater than the pressure applied by the pressure application device to the cleaning liquid supplied to the cleaning liquid nozzles on a lower side of the inclined cleaning liquid emission surface.

11. The apparatus as defined in claim 10, wherein a flow channel resistance from the inlet port to one of the cleaning liquid nozzles on the upper side of the inclined cleaning liquid emission surface is smaller than a flow channel resistance from the inlet port to one of the cleaning liquid nozzles on the lower side of the inclined cleaning liquid emission surface.

12. The apparatus as defined in claim 10, wherein a flow channel resistance from the inlet port to each of the cleaning liquid nozzles successively increases from one of the cleaning liquid nozzle on the upper side of the inclined cleaning liquid emission surface toward one of the cleaning liquid nozzles on the lower side of the inclined cleaning liquid emission surface, such that the cleaning liquid nozzles have a uniform pressure distribution.

13. The apparatus as defined in claim 12, wherein the cleaning liquid nozzles and the flow channels have a structure whereby a sum of difference in pressure loss caused by a variation in the flow channel resistance and difference in liquid head pressure produced by the inclination of the cleaning liquid emission surface is constant.

14. The apparatus as defined in claim 10, wherein:
the inlet port is arranged nearer to the upper side of the inclined cleaning liquid emission surface than the lower side of the inclined cleaning liquid emission surface; and
a length of a flow channel from the inlet port to one of the cleaning liquid nozzles on the upper side of the inclined cleaning liquid emission surface is shorter than a length of a flow channel from the inlet port to one of the cleaning liquid nozzles on the lower side of the inclined cleaning liquid emission surface.

15. The apparatus as defined in claim 10, wherein:
the inlet port is arranged nearer to the upper side of the inclined cleaning liquid emission surface than the lower side of the inclined cleaning liquid emission surface; and
a length of a flow channel from the inlet port to each of the cleaning liquid nozzles successively increases from one of the cleaning liquid nozzles on the upper side of the inclined cleaning liquid emission surface toward one of the cleaning liquid nozzles on the lower side of the inclined cleaning liquid emission surface, such that the cleaning liquid nozzles have a uniform pressure distribution.

16. The apparatus as defined in claim 15, wherein the cleaning liquid nozzles and the flow channels have a structure whereby a sum of difference in pressure loss caused by a variation in flow channel resistance and difference in liquid head pressure produced by the inclination of the cleaning liquid emission surface is constant.

17. The apparatus as defined in claim 10, further comprising:
a cleaning liquid tank which stores the cleaning liquid to be supplied to the cleaning liquid nozzles; and
a vertical movement device which moves the cleaning liquid nozzles and the cleaning liquid tank relatively to each other in a vertical direction,
wherein the pressure application device applies the pressure to the cleaning liquid to be emitted from the cleaning liquid nozzles using a liquid head pressure differential between the cleaning liquid nozzles and the cleaning liquid tank.

18. The apparatus as defined in claim 10, wherein:
the inlet port includes a first inlet port connected to the cleaning liquid nozzles on the upper side of the inclined cleaning liquid emission surface, and a second inlet port connected to the cleaning liquid nozzles on the lower side of the inclined cleaning liquid emission surface; and
the pressure application device includes a first pressure application device which applies the pressure to the cleaning liquid supplied to the cleaning liquid nozzles on the upper side of the inclined cleaning liquid emission surface through the first inlet port, and a second pressure application device which applies the pressure to the cleaning liquid supplied to the cleaning liquid nozzles on the lower side of the inclined cleaning liquid emission surface through the second inlet port.

19. A method of cleaning an inkjet head having a liquid ejection surface oblique to a horizontal plane, the method comprising the steps of:
applying cleaning liquid to the liquid ejection surface by emitting the cleaning liquid from a plurality of cleaning liquid nozzles that are arranged in a cleaning liquid emission surface arranged with an inclination so as to face the liquid ejection surface of the inkjet head, the cleaning liquid nozzles being arranged in a line substantially parallel with a direction of the inclination of the cleaning liquid emission surface; and
adjusting pressure applied to the cleaning liquid supplied to the cleaning liquid nozzles on an upper side of the inclined cleaning liquid emission surface so as to be greater than pressure applied to the cleaning liquid supplied to the cleaning liquid nozzles on a lower side of the inclined cleaning liquid emission surface.
